(19) United States
(12) Patent Application Publication
(10) Pub. No.: US 2008/0153503 A1
(43) Pub. Date: Jun. 26, 2008

(54) ENHANCED USER AND CALLER NOTIFICATIONS FOR A MULTIMODAL PHONE BEING USED IN A MODE OTHER THAN ONE OVER WHICH A COMMUNICATION ATTEMPT IS MADE

(75) Inventors: MANISH BIRLA, BANGALORE (IN); VINUTHANANDA BINDINGANAVILE, BANGALORE (IN); ROBERTO GAUTIER, DAVIE, FL (US); RICARDO MARTINEZ-PEREZ, PLANTATION, FL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/614,822

(22) Filed: Dec. 21, 2006

(51) Int. Cl. H04Q 7/20

(52) U.S. Cl. 455/450

(57) ABSTRACT

A system and method for a dual mode device to intelligently handle incoming communications can include a mobile communication device and a notification engine. The mobile communication device can have more than one communication mode. The notification engine can perform an intelligent notification action whenever the mobile communication device is actively engaged in a communication session and an incoming call for a new session is received. The active session and the new session can correspond to different communication modes that are unable to be concurrently used. One configuration for an intelligent notification can be to selectively notify the mobile device user of the call depending upon a caller's importance level Another configuration for the intelligent notification can be to notify a blocked caller that the called device is busy or is actively being used for communications involving the original communication mode.

### BACKGROUND

1. Field of the Invention

The present invention relates to dual mode mobile communication devices and, more particularly, to a dual mode mobile communication device that intelligently handles incoming dispatch calls when another communication channel is in use.

2. Description of the Related Art

Creation of dual mode devices and other technological advances have made it possible for mobile communication devices to utilize more than one transmission channel or mode, such as a data channel, a dispatch channel, and/or an interconnect channel. These devices are often referred to as dual mode or multi mode devices, which for simplicity are referred to generically hereafter as dual mode devices. Dual mode devices can face a scenario in which one communication channel is active and a different channel wants to come into service. Even short periods of simultaneous deal transmissions can be disallowed for some dual mode device implementations. For example. Federal Communication Commission (FCC) guidelines, such as Specific Absorption Rate (SAR) requirements, can be violated when a mobile device transmits over more than one channel at a time. Antenna diversity, software/firmware infrastructure, service agreements, and other considerations can also limit a mobile device to a single active communication channel at a time.

A limitation of using one mode at a time creates numerous problems relating to device use. These problems will escalate as more phones utilize modern data transmission features, such as 3G or 4G high-bandwidth data communications. To illustrate, one problem relates to notifying a user of an incoming communication attempt that requires one communication channel, when another communication channel is in use. For example, a user can actively use a data communication channel (e.g., Web browsing, accessing a remote desktop, or file downloading) when a dispatch communication is received A user may desire to be notified immediately of dispatches from a select group of important people, such as people in a contact list. At the same time, a user may not want to have their current data communication channel interrupted by dispatches from other people, such as phone solicitors or casual acquaintances. At present, no know solution permits the user to be selectively notified of a new dispatch based upon a caller's identity.

Another problem related to single mode restrictions pertains to notifications received by callers. At present, when services are being provided by a dual mode device over one communication channel, other services relating to other channels are blocked. For example, when a user of an Integrated Digital Enhanced Network (iDEN)-Code Division Multiple Access (CDMA) dual mode device uses a CDMA based interconnect service (CDMA), iDEN based dispatch services are blocked. A caller attempting to send a dispatch to the iDEN-CDMA device receives a “user unavailable message” whenever the iDEN-CDMA device is being used for a voice call. The caller typically responds by retrying the dispatch believing the communication attempt did not succeed due to a potential network problem. The “user unavailable message” provides the caller with misleading feedback, which leads to confusion. No known solution permits a caller to receive accurate feedback when an incoming dispatch attempt is blocked due to a called dual mode device being used in a different mode.

### SUMMARY OF THE INVENTION

The present invention can be implemented in accordance with numerous aspects consistent with the material presented herein. One aspect of the present invention can include a system for a dual mode device to intelligently handle incoming communications. The system can include a mobile communication device and a notification engine. The mobile communication device can have more than one communication mode. The notification engine can perform an intelligent notification action whenever the mobile communication device is actively engaged in a communication session and an incoming call for a new session is received. The active session and the new session can use different communication modes that are unable to be concurrently used.

One configuration for an intelligent notification can be to selectively notify the mobile device user of the call depending upon a caller's importance level. That is, when a caller is important, a prompt notifying the user of the incoming call can be presented, otherwise no prompting will occur until after the active communication session is ended. Another configuration for the intelligent notification can notify a blocked caller that the called device is busy or is actively being used for communications involving an original communication mode and a different mode. For example, the original mode can be a data traffic mode or an interconnect mode and the new communication mode can be a dispatch mode.

Another aspect of the present invention can include a method for intelligently handling incoming communications in a dual mode communication device. The method can include a step of establishing an active communication session over a first type of communication channel involving a dual mode communication device and a first communicating device. The dual mode communication device can receive an incoming request from a second communicating device for a second communication session over a second type of communication channel. The dual mode device can be prevented from concurrently activating two different communication channels, whenever the channels are of the first and second type. The incoming request can be blocked and a busy indicator can be conveyed to the second communicating device.

Still another aspect of the present invention can include a different method for intelligently handling incoming communications in a dual mode communication device. This method can also include a step of establishing an active communication session over a first type of communication channel involving a dual mode communication device and a first communicating device. The dual mode communication device can receive an incoming request from a second communicating device for a second communication session over a second type of communication channel. An importance value of a caller making the incoming request can be automatically determined. A user of the dual mode communication device can be selectively notified of the incoming request based upon the importance value. When the caller has a relatively high importance value, the user can be notified immediately of the communication attempt. When the caller has a relatively low importance value, the user may not be notified of the communication attempt until after the active communication session ends. The notification can present either a calling number or an identifier of the caller to the user of the dual mode communication device.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for a dual mode communication device to intelligently handle incoming communications in accordance with an embodiment of the inventive arrangements disclosed herein.

FIG. 2 is a flow chart of a method for determining if an incoming communication is important and based upon this determination selectively notifying a receiving device user of the incoming communication attempt in accordance with an embodiment of the inventive arrangements disclosed herein.

FIG. 3 is a flow chart of a method for a conveying a busy signal to a calling device when a dual mode device is busy with a different communication occurring over a different communication channel in accordance with an embodiment of the inventive arrangements disclosed herein.

FIG. 4 is a flow diagram of a dual mode device that intelligently handles incoming communications when a mutually exclusive channel is already in use in accordance with an embodiment of the inventive arrangements disclosed herein.

### DETAILED DESCRIPTION OF THE INVENTION

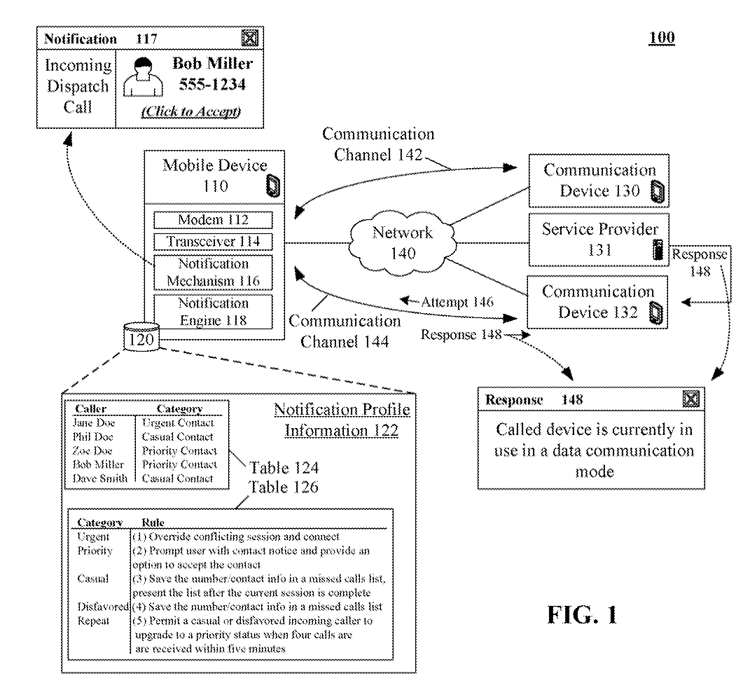

FIG. 1 is a schematic diagram of a system 100 for a dual mode communication device 110 to intelligently handle incoming communications in accordance with an embodiment of the inventive arrangements disclosed herein. The dual mode communication device can be a mobile device 110 able to communicate with device 130 over channel 142 and with communication device 132 over channel 144. Communications between device 110 and device 130, 132 can be direct peer-to-peer communications over network 140 and/or can involve a service provider 131. The mobile device 110 can be restricted so that it is unable to communicate over channels 142 and 144 concurrently.

One aspect of the intelligent handling of calls is to selectively notify a user of device 110 when communications are incoming over a channel 144, when the device 110 is already transmitting over channel 142. The notifications are selectively based upon an importance of an incoming communication. Communication importance can be determined by the notification engine 118 based upon notification profile information 122 stored in data store 120.

The information 122 can include a caller/category table 124, which assigns an importance category to specific callers. As shown in the sample table 124, Jane Doe can be specified as an urgent contact, Zoe Doe and Bob Miller can be priority contacts, and Phil Doe and Dave Smith can be casual contacts.

Table 126 can associate different notification rules with different categories. An urgent category can correspond to a rule that automatically overrides a conflicting communication session (i.e., an active session over channel 142 when the incoming communication is over channel 144). A priority contact can correspond to a rule that prompts a user with a contact notice and provides an option to accept the incoming communication. A casual category can correspond to a rule that saves the number/contact information in a missed calls list and automatically presents the list upon device 110 after the current communication session (e.g., the session over channel 142) is completed. A disfavored category can save the number/contact information of the incoming calls in a missed calls list, which is not automatically presented after the current communication session is completed. A repeat category can correspond to a rule that permits an incoming call otherwise having a casual or disfavored category value to be upgraded to a priority category value whenever tour or more calls were received from the same calling device within a five minute interval.

It should be appreciated that the categories and rules shown in the notification profile information 122 are for illustrative purposes only and that the invention is not limited in this regard. Any number of categories can be established and associated with any number and type of notification rule.

The notification mechanism 116 can be any mechanism of device 110 that can notify a user of an incoming communication attempt. Mechanism 116 can use an audible, visual, and/or tactile indicator. For example, a notification 117 can be visually presented upon a display of device 110. The device can also vibrate, beep, and the like, to indicate an incoming communication attempt. When device 110 is implemented as a clam shell shaped device, the notification mechanism 116 can present different notifications depending upon whether the clam shell is opened or closed. For example, when closed, a display on the outer surface of the clam shell can display a picture and textual message of the incoming caller. The notification mechanism 116 is only activated when an incoming caller is determined to be important by the notification engine 118 as previously noted.

Another aspect of the intelligent handling of calls is to selectively notify a caller (of device 132) when a communication attempt 146 with device 110 is not possible due to the device 110 being busy because of a communication over a different communication channel 142. When such is the case, a busy indicator is conveyed in a response 148 to the calling device 132. The response 148 can be generated by device 110 or by service provider 131 depending upon implementation specifics. In one embodiment, reliance upon a service provider 131 to handle incoming calls/busy signals can result in power savings for the mobile device 110. For example, since the device 110 when actively using a channel may only be looking towards that channel for mobility updates, a control channel duty cycle can be changed so that the device 110 is not monitoring channels other the active one. Changing the control channel duty cycle can reduce current drain, thereby enhancing battery life of the mobile device 110.

Unlike conventional solutions, which simply indicate device 110 is unavailable, the response 148 can indicate that the called device (110) is currently busy and engaged in a communication session having a different communication mode. To illustrate, channel 142 can be a data traffic channel and channel 144 can be a dispatch channel, where the response indicates that mobile device 110 is busy performing data traffic operations. The response 148 can be an audible, visual, and/or any other indication means to convey a busy status to a user of device 132.

As shown, mobile communication device 110 can be any dual mode communication device capable of communicating over more than one different type of communication channel. For example, device 110 can be mobile telephone, a notebook computer, a tablet computer, a wearable computer, an embedded computer, a mobile email appliance, a media player, an entertainment system, and the like.

Each of the communication channels 142 and/or 144 can be a pathway over which information encoded within a carrier wave is conveyed. Each channel 142 and/or 144 can be associated with a different modem 112, where the device 110 is prevented from concurrent transmissions involving both modems 112. Communication channels can include, but are not limited to, a CDMA based channel, a Time Division Multiple Access (TDMA) based channel, a Global System for Mobile Communication (GSM) based channel, an iDEN based channel, a QCHAT based channel, a wireless local area networks (WLAN) based channel, a Worldwide Interoperability for Microwave Access (WiMax) based channel, a BLUETOOTH based channel, and the like.

Devices 130 and/or 132 can be a mobile communication device, similar to device 110, or can be a fixed device. For example, devices 130 and/or 132 can include customer premise equipment (CPE) such as a telephone. Each of the devices 130 and/or 132 can also be a desktop computer, a Web server, an automated interactive response system (IVR), and the like.

Device 110 can include one or more transceiver 114, and at least one modem 112. The transceiver 114 can be a wireless transceiver that permits digital content to be exchanged between device 110 and device 130 or 132. Different transceivers 114 can be included for communication over different channels. For example, one transceiver 114 can be a wide area network (WAN) transceiver for mobile telephony and data communications and another can be a personal area network (PAN) transceiver for BLUETOOTH, WIFI, and/or other PAN communications. One or more modems 112 can be used to physically support simultaneous services, such as data and dispatch.

Network 140 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 140 can include local components and data pathways necessary for communications to be exchanged among computing device components and between integrated device components and peripheral devices. The network 140 can also include network equipment, such as routers, data lines, hubs, and intermediary servers which together form a packet-based network, such as the Internet or an intranet. The network 140 can further include circuit-based communication components and mobile communication components, such as telephony switches, modems, cellular communication towers, and the like. The network 140 can include line based and/or wireless communication pathways.

Data store 120 can be a physical or virtual storage space configured to store digital content. Data store 120 can be physically implemented within any type of hardware including, but not limited to, a magnetic disk, an optical disk, a semiconductor memory, a digitally encoded plastic memory, a holographic memory, or any other recording medium. Further, data store 120 can be a stand-alone storage unit as well as a storage unit formed from a plurality of physical devices. Additionally, content can be stored within data store 120 in a variety of manners. For example, content can be stored within a relational database structure or can be stored within one or more files of a file storage system, where each file may or may not be indexed for information searching purposes.

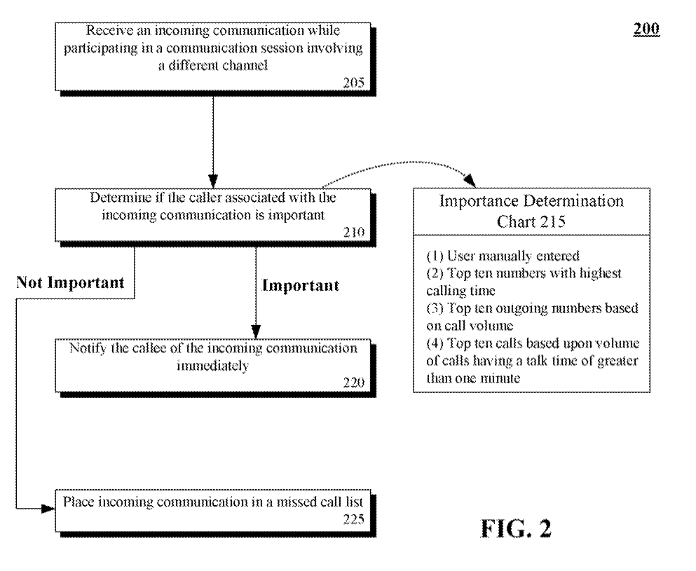

FIG. 2 is a flow chart of a method 200 for determining if an incoming communication is important and based upon this determination selectively notifying a receiving device user of the incoming communication attempt in accordance with an embodiment of the inventive arrangements disclosed herein. The method 200 can be performed in the context of system 100 or in the context of any dual mode communication device.

Method 200 can begin in step 205, where a communication initialization request can be received that is associated with a communication channel while a different communication is being conducted by the receiving device over a different communication channel. The two communication channels can be mutually exclusive in terms of being unable to be concurrently utilized. For example, each communication channel can utilize a different modem of the receiving device, where the modems are not permitted to be concurrently activated for transmission purposes. The receiving device can include, but is not limited to, an iDEN/CDMA mobile phone, an iDEN/GSM phone, a WiMAX/iDEN phone, a WiMAX/CDMA phone, a GMS/WiMAX phone, a WiMax/DORA phone, and any other communication device having two or more mutually exclusive transmission channels.

In step 210, a determination can be made as to whether the incoming communication is from an “important” caller. This determination can be performed in many different ways, such as being based upon the notification profile information 122 of system 100. The determination can also be based upon a set of static and/or dynamic conditions, as shown in chart 215.

One of these conditions can be whether a caller or calling device is included in a manually entered list of important contacts. In one embodiment, this list can include phone book entries and/or speed dial entries stored on the receiving device. Another condition for importance determination shown in chart 215 is whether the incoming caller is included in a top N list of contacts, which is based upon calling time. A different condition can be based upon the incoming caller is within the top N number of contacts based upon an outgoing call history. Still another condition can be whether the incoming caller is within the top N number of contacts based upon calling frequency. In each instance, N can be a configurable value. These conditions are for illustrative purposes only and the invention is not to be construed as limited in this regard.

Regardless of how importance is determined, when the caller is important, the method can proceed from step 210 to step 220, where a notification can be presented to the user. This notification can be an audible, a visual, a haptic (e.g., vibration), and/or other type of notification. A user can optionally choose to accept the incoming communication, which automatically ends the preexisting communication. When the caller is not important, the method can proceed from step 210 to step 225, where the incoming communication can be placed in a missed call queue. When the current communication ends, the missed call queue can optionally be automatically presented to the receiving device user.

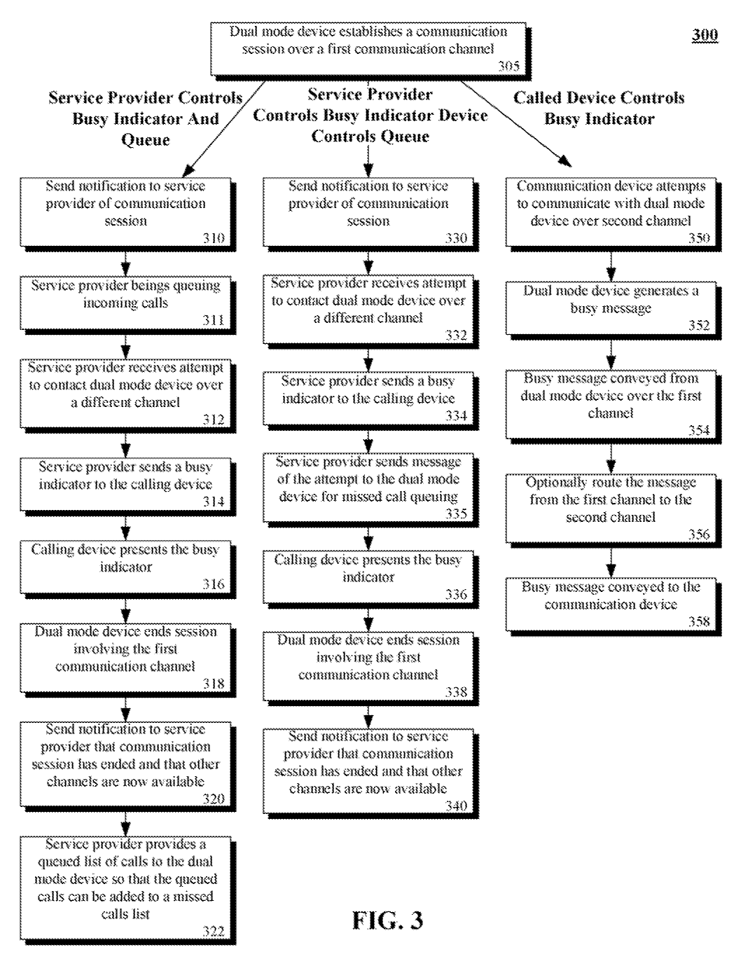

FIG. 3 is a flow chart of a method 300 for a conveying a busy signal to a calling device when a dual mode device is busy with a different communication occurring over a different communication channel in accordance with an embodiment of the inventive arrangements disclosed herein. The method 300 can be performed in the context of system 100.

Method 300 can begin in step 305, where a dual mode device establishes a communication channel over a first communication channel. The method can branch depending upon implementation specifics to a branch consisting of steps 310-322 where a network element handles a busy indication and queuing, to a branch 330-340 where a network element handles a busy indication and where the dual mode device handles queuing, and to a branch consisting of steps 350-358 where a receiving device handles a busy indication and queuing.

In one embodiment, when the dual mode device is implemented in accordance with steps 310-322 or 330-340 power saving measures can be taken to enhance the battery life of the dual mode device. For example, the control duty cycle of the dual mode device can be changed to reduce current drain, since when actively using a channel the dual mode device is only looking towards that channel for mobility updates.

In step 310, a notification can be sent from the dual mode device to a service provider that informs the service provider that the device is engaged in the communication session and is unable to communicate over channels other than the first communication channel while this communication session is active. In step 311, the service provider can begin queuing incoming calls directed towards the dual mode device. In step 312, the service provider can receive an attempt to contact the dual mode device over a different (second) communication channel. Concurrent communications can be disallowed by the dual mode device over the first and the incoming channel. In step 314, the service provider can send a busy indicator to the calling device. In step 316, the calling device can present the busy indicator. In step 318, the dual mode device can end the session involving the first channel. In step 320, a notification can be sent to the service provider that indicates the communication session has ended and that other communication channels are now available. In step 322, the service provider can provide the queued list of calls to the dual mode device so that the queued calls can be added to a missed calls list.

In step 330, a notification can be sent from the dual mode device to a service provider that informs the service provider that the device is engaged in an active communication session that prevents receipt of calls over other channels. In step 332, the service provider can receive an attempt to contact the dual mode device over a different (second) communication channel. In step 334, the service provider can send a busy indicator to the calling device. In step 335, the service provider can send a message of the communication attempt to the dual mode device, which can add the attempt to a missed call queue. This can occur without interrupting the active communication session. In step 336, the calling device can present the busy indicator. In step 338, the dual mode device can end the session involving the first channel. In step 340, a notification can be sent to the service provider that indicates the communication session has ended and that other communication channels are now available.

In step 350, a communication device can attempt to communicate with the dual mode device over a second communication channel which is unable to be concurrently activated with the first communication channel. In step 352, the dual mode device can generate a busy message and can add the communication attempt to a missed call queue. In step 354, the busy message can be conveyed from the dual mode device over the first communication channel. Notably, the busy message may not be permitted to be sent directly to the calling device over the second communication channel since the dual mode device is not permitted to simultaneously transmit over both the first and the second communication channels. In optional step 356, a service provider or network element can convert the busy message from the first communication channel to the second communication channel, where it can be directly conveyed to the device in step 358. If no conversion is performed (step 356 skipped) then the busy message can be conveyed directly to the calling device over the first communication channel, which requires the calling device to be a dual mode device capable of communicating over the first and second communication channels.

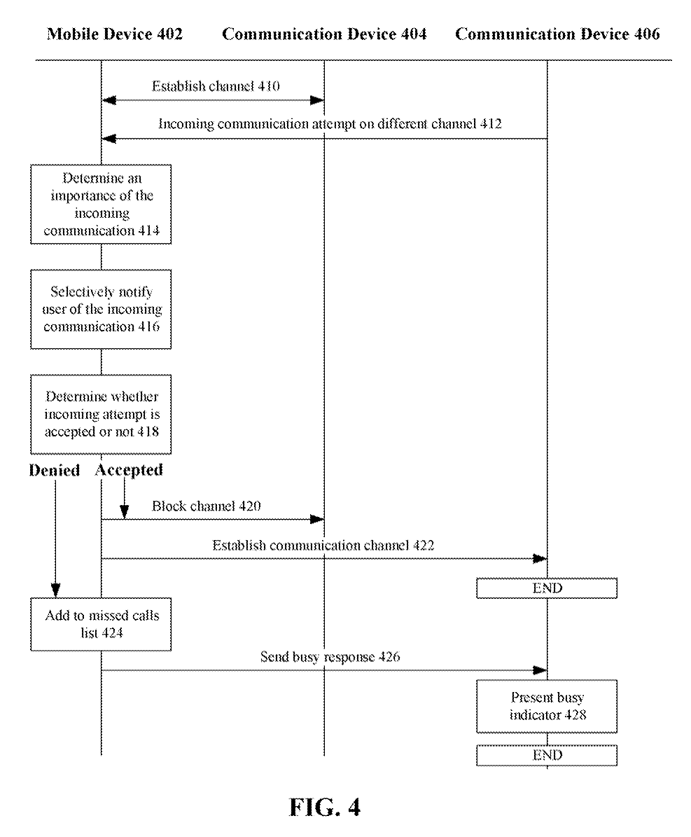

FIG. 4 is a flow diagram of a dual mode device that intelligently handles incoming communications when a mutually exclusive channel is already in use in accordance with an embodiment of the inventive arrangements disclosed herein. In a beginning state, a communication channel 410 can be established between mobile device 402 and communication device 404. The mobile device 402 can be a dual channel communication device. A different communication device 406 can attempt to establish a new communication session 412 with device 402 over a separate channel, which is unable to concurrently operate with the channel used by device 404.

In step 414, the mobile device 402 can determine whether the caller associated with device 406 is important. In step 416, mobile device 402 can selectively notify a user of the incoming communication based upon results of step 414 (i.e., as shown in method 200). In step 418, the device 402 can determine whether the communication from device 406 is to be accepted. For example, if a caller is important enough as determined by step 414, the communication can be automatically accepted. In another example, a callee can select to accept the communication after being presented with the notification of step 418 that results in the communication channel with device 404 being blocked 420. A different communication channel 422 can then be established between device 402 and device 406.

If the incoming communication is not accepted in step 418, step 424 can execute, where the incoming communication can be added to a missed call list of device 402. A busy indicator 426 can also be sent to device 406. In step 428, the device 406 can present the busy indicator to a device user.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A system for a dual mode device to intelligently handle incoming communications comprising:
a mobile communication device having a plurality of communication modes;
a notification engine configured to perform an intelligent notification action whenever the mobile communication device is actively engaged in a communication session over a first one of the communication modes at a time that a communication attempt for a different communication session is made over a second one of the communication modes, wherein the first and the second communication modes are unable to be concurrently activated, and wherein said intelligent notification action is selected from a group of actions consisting of an action of selectively notifying a user of the mobile communication device of the communication attempt depending upon an importance of a caller making the communication attempt and an action consisting of denying the communication attempt and notifying the caller that the mobile communication device is in a busy state.

2. The system of claim 1, wherein the intelligent notification action is the action of selectively notifying a user of the mobile communication device of the communication attempt depending upon an importance of a caller making the communication attempt.

3. The system of claim 2, wherein the notification action is conducted by performing at least one of the following: audibly notifying the user, visibly notifying the user using a display screen, blinking an LED of the mobile communication device, and vibrating the mobile communication device.

4. The system of claim 2, wherein the selectively notifying action is performed without disturbing a state of the communication session occurring over the first communication mode.

5. The system of claim 2, wherein the first communication mode is a data traffic communication mode and the second communication mode is a dispatch communication mode.

6. The system of claim 2, wherein a caller is determined to be important enough to notify the user when the caller is at least one of the following: included in a manually entered list, within a top N list of callers of the mobile communication device based upon calling time, within a top N list of callers of the mobile communication device based upon calling frequency, a repetitive caller who has attempted to establish communications with the mobile communication device at least S times within a duration of T, wherein N, S, and T are previously configured values established within the mobile communication device.

7. The system of claim 1, wherein the intelligent notification action is the action denying the communication attempt and notifying the caller that the mobile communication device is in a busy state.

8. The system of claim 7, wherein the busy state is conveyed to the caller by a service provider of the mobile communication device.

9. The system of claim 8, wherein the mobile communication device conserves power by changing a control channel duty cycle when a channel is active and when the service provider is handling incoming calls over other channels.

10. The system of claim 7, wherein the busy state is conveyed to the caller by the mobile communication device.

11. The system of claim 10, wherein the busy state is conveyed to the caller using the first communication mode.

12. The system of claim 7, wherein the first communication mode is a data traffic communication mode and the second communication mode is a dispatch communication mode.

13. A method for intelligently handling incoming communications in a dual mode communication device comprising:
establishing an active communication session over a first type of communication channel involving a dual mode communication device and a first communicating device;
the dual mode communication device receiving an incoming request from a second communicating device for a second communication session over a second type of communication channel, wherein the dual mode device is prevented from concurrently activating two different communication channels one of the first type and the other of the second type;
blocking the incoming request; and
conveying a busy indicator to the second communicating device.

14. The method of claim 13, wherein a service provider of the dual mode communication device performs the blocking and the conveying steps.

15. The method of claim 14, further comprising:
whenever the service provider is responsible for performing the blocking and the conveying steps, changing a control channel duty cycle of the dual mode communication device to conserve power.

16. The method of claim 13, wherein the dual mode communication device performs the blocking and the conveying steps.

17. The method of claim 13, wherein the second type of communication channel is a dispatch type.

18. The method of claim 13, further comprising:
automatically determining an importance value of a caller making the incoming request; and
selectively notifying a user of the dual mode communication device of the incoming request based upon an importance value associated with the caller.

19. A method for intelligently handling incoming communications in a dual mode communication device comprising:
establishing an active communication session over a first type of communication channel involving a dual mode communication device and a first communicating device;
the dual mode communication device receiving an incoming request from a second communicating device for a second communication session over a second type of communication channel, wherein the dual mode device is prevented from concurrently activating two different communication channels one of the first type and the other of the second type;
automatically determining art importance value of a caller making the incoming request; and
selectively notifying a user of the dual mode communication device of the incoming request, wherein when the caller has a relatively high importance value the user is notified immediately of the incoming request, and wherein when the caller has a relatively low importance value the user is not notified of the incoming request until after the active communication session ends.

20. The method of claim 19, wherein the first type of communication channel is a data traffic communication channel, and wherein the second type of communication channel is a dispatch communication channel.
